(19) United States
(12) Patent Application Publication
(10) Pub. No.: US 2026/0148883 A1
(43) Pub. Date: May 28, 2026

(54) HIGH TEMPERATURE RESISTANT RESISTOR

(71) Applicant: VIKING TECH CORPORATION, Hsinchu County (TW)

(72) Inventors: Shun-Ho KUO, Hsinchu County (TW); Chi-Yu LU, Hsinchu County (TW)

(21) Appl. No.: 18/962,147

(22) Filed: Nov. 27, 2024

(51) Int. Cl. H01C 7/18; H01C 1/14

(52) U.S. Cl. CPC H01C 7/18; H01C 1/14

(57) ABSTRACT

A high-temperature resistant resistor is provided and includes a substrate layer, a first surface electrode layer, and a second surface electrode layer. The first surface electrode layer is disposed on a first surface of the substrate layer, the resistance layer partially attaches the first electrode layer and the substrate layer, the second surface electrode layer is aligned with the first surface electrode layer, and attached on the first surface electrode layer and the resistance layer, so that the resistance layer is fixed between the first electrode layer and the second electrode layer. The first surface electrode layer, the resistance layer and the second surface electrode layer form a composite structure to suppress the change in resistance value of the high-temperature resistant resistor at high temperatures.

### 1. FIELD OF THE INVENTION

The present invention relates to a thin film resistor, particularly to a high-temperature resistant thin film resistors with a composite electrode structure.

### 2. DESCRIPTION OF THE PRIOR ART

As the demand of the performance for products increase, passive components require a wide range of working temperatures for operating in harsh environment, high-temperature production line, or high-power modules. However, due to the limitations of the inherent properties of material, technical problems can be found when using conventional passive components at high temperatures, such as short lifetime and high lost.

For example, the working temperature of conventional thin film resistors is typically between 20° C. to 150° C. At temperatures greater than 150° C., each layer of the thin film resistors has different temperature coefficient of resistance and coefficient of thermal expansion, i.e. metal electrode layer has higher resistance at high temperatures; therefore, thin film resistors is prone to thermal deformation and resistance drift, which result in reduces of accuracy and reliability of thin film resistors.

### SUMMARY OF THE INVENTION

The present disclosure provides a high-temperature resistant thin film resistor with a composite electrode structure, which can effectively reduce the resistance drift at a temperature greater than 150° C., details will be described below.

A high-temperature resistant resistor is provided and includes a substrate layer, a first surface electrode layer, and a second surface electrode layer. The first surface electrode layer is disposed on a first surface of the substrate layer. A resistive layer is partially attached on the first surface electrode layer and the substrate layer. A second surface electrode layer is aligned with the first surface electrode layer and attached on the first surface electrode layer and the resistive layer, thereby clamping the resistive layer between the first surface electrode layer and the second surface electrode layer. The first surface electrode layer, the resistive layer, and the second surface electrode layer form a composite structure to suppress a resistance change of the high-temperature resistant resistor at high-temperature.

Preferably, the high-temperature resistant resistor further includes a back electrode layer. The back electrode is disposed on the second surface of the substrate layer with respect to the first surface electrode layer.

Preferably, the high-temperature resistant resistor further includes a protective layer. The protective layer is disposed on the resistive layer and is attached on the second surface electrode layer and the resistive layer.

Preferably, the protective layer is made of epoxy resin.

Preferably, the high-temperature resistant resistor further includes a first side electrode layer. The first side electrode layer partially cover the protective layer, the second surface electrode layer, the first surface electrode layer, the substrate layer, and the back electrode layer.

Preferably, the high-temperature resistant resistor further includes a second side electrode layer. The second side electrode layer covers the first side electrode layer.

Preferably, the first side electrode layer is made of nickel.

Preferably, the second side electrode layer is made of tin.

Preferably, the resistive layer is made of nickel-chromium alloy or silicon-chromium alloy.

Preferably, the high-temperature resistant resistor is a thin film resistor.

### BRIEF DESCRIPTION OF THE DRAWINGS

Implementations of the present technology will now be described, by way of embodiment, with reference to the attached figures.

FIG. 1 is a schematic view showing an embodiment of the high-temperature resistant resistor of the present invention.

FIG. 2 is a schematic cross-sectional view showing the high-temperature resistant resistor taken along the cutting plane line A-A′ of FIG. 1, with the first side electrode layer and the second side electrode layer.

FIG. 3 is a flowchart of an embodiment of a method for manufacturing a high-temperature resistant resistor.

### DESCRIPTION OF THE PREFERRED EMBODIMENT

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents, as can be included within the spirit and scope of the described embodiments, as defined by the appended claims. Thereinafter, the implementation invention and the related embodiment will be described to illustrate the characteristics of the present invention. However, the embodiment well known by the persons skilled in that art may not be specifically described in the specification.

For simplicity of explanation, a rectangular resistor is employed as an example. It shall be understood that it is used as an example and not to limit the present disclosure. The high-temperature resistant resistor of the present disclosure can be implemented in any shape.

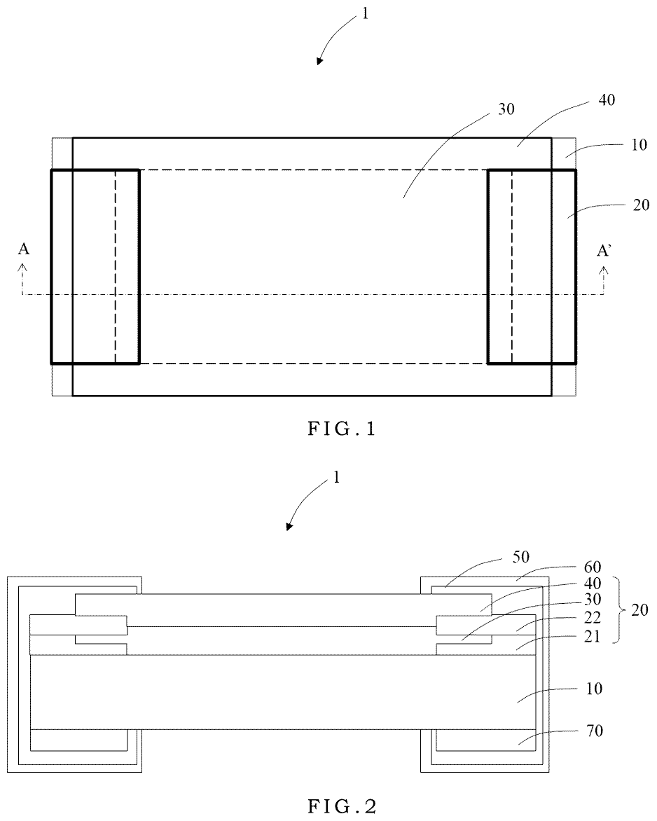

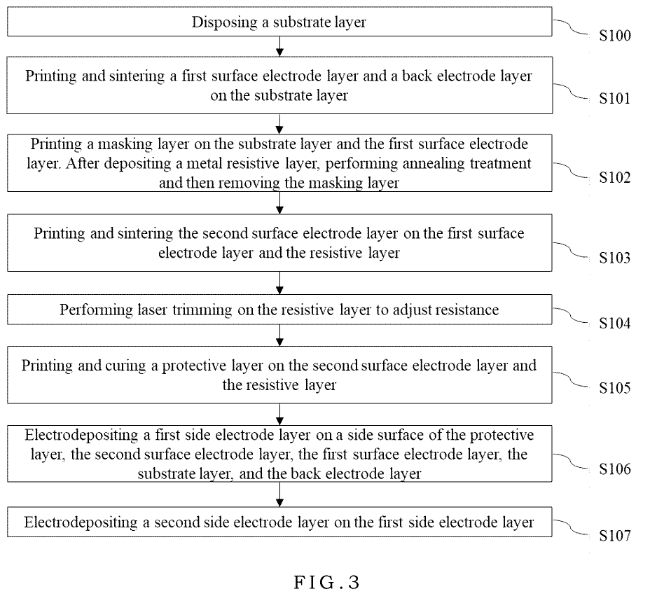

Refer to FIGS. 1-3. FIG. 1 is an embodiment of the high-temperature resistant resistor of the present disclosure. FIG. 2 is a schematic cross-sectional view showing the high-temperature resistant resistor taken along the cutting plane line A-A′ of FIG. 1, with the first side electrode layer and the second side electrode layer. FIG. 3 is a flowchart of a method of manufacturing the high-temperature resistant resistor of the present disclosure.

The present disclosure provides a high-temperature resistant resistor 1 and include a substrate layer 10, a first surface electrode layer 21, a resistive layer 30, a second surface electrode layer 22, a back electrode layer 70, a protective layer 40, and a first side electrode layer 50, and the second side electrode layer 60. The first surface electrode layer 21, the second surface electrode layer 22, the resistive layer 30, and the protective layer 40 form a composite structure 20 to increase the capability of heat tolerance of the resistor and inhibit the resistance change of the high-temperature resistant resistor at high-temperatures. Preferably, the high-temperature resistant resistor 1 is a thin film resistor.

The method of manufacturing the high-temperature resistance resistant resistor 1 of the present disclosure is described below:

Step S100, disposing a substrate layer 10. A material of the substrate layer 10 may be alumina, with a purity of 96%-99%.

Step S101, printing a first surface electrode layer 21 and a back electrode layer 70 on the substrate layer 10, and sintering at 850° C. such that the first surface electrode layer 21 is formed on a first surface of the substrate layer 10, the back electrode layer 70 is disposed on a second surface of the substrate layer 10 with respect to the first surface electrode layer 21. A material of the first surface electrode layer 21 can be the same as a material of the back electrode layer 70. The material of the first surface electrode layer 21 and the material of the back electrode layer 70 can be independently selected from silver or copper.

Step S102, printing a masking layer on the substrate layer 10 and the first surface electrode layer 21. After depositing a metal resistive layer 30, performing annealing treatment and then removing the masking layer so that the resistive layer 30 partially attached on the first surface electrode layer and the substrate layer 10. A material for the resistive layer 30 can be selected from nickel-chromium alloy or silicon-chromium alloy.

Step S103, printing the second surface electrode layer 22 on the first surface electrode layer 21 and the resistive layer 30, then sintering at 850° C. The second surface electrode layer 22 is aligned with the first surface electrode layer 21 and is attached on the first surface electrode layer 21 and the resistive layer 30, thereby clamping the resistive layer 30 between the first surface electrode layer 21 and the second surface electrode layer 22. A material of the second surface electrode layer 22 can be the same as the material of the first surface electrode layer 21 and can be selected from silver or copper.

In some embodiments, a thickness ratio of the first surface electrode layer 21, the second surface electrode layer 22, and the back electrode layer 70 is 1:1:1.

In some embodiments, a thickness of the resistive layer 30 is less than a thickness of the first surface electrode layer 21 and a thickness of the second surface electrode layer 22, thereby forming a groove.

Step S104, performing laser trimming on the resistive layer 30 to adjust resistance based on a required resistance.

Step S105, printing a protective layer 40 on the second surface electrode layer 22 and the resistive layer 30, and then curing the protective layer 40. The protective layer 40 is disposed with respect to the resistive layer 30 and is attached on the second surface electrode layer and the resistive layer 30. A size of the protective layer 40 may be equal to or greater than the resistive layer 30 to fill within the groove to form a composite structure 20, thereby enhancing an overall thermal stability of the high-temperature resistant resistor 1. A material of the protective layer 40 can be epoxy resin.

Step S106: Electrodepositing a first side electrode layer 50 on a side surface of the protective layer 40, the second surface electrode layer 22, the first surface electrode layer 21, the substrate layer 10, and the back electrode layer 70, so that the first side electrode layer 50 partially covers the protective layer 40, the second surface electrode layer 22, the first surface electrode layer 21, the substrate layer 10, and the back electrode layer 70. A material of first side electrode layer 50 may be nickel.

Step S107: Electrodepositing a second side electrode layer 60 on the first side electrode layer 50, such that the second side electrode layer 60 completely covers an entirety of the first side electrode layer 50. A material of second side electrode layer 60 can be tin.

In order to determine the heat tolerance of the high-temperature resistant resistor of the present disclosure, a conventional thin-film resistor which without the composite structure 20 of the present disclosure is used as a comparative example, while the present disclosure is used as an implementation example. Each of resistor having a resistance of 10KΩ was measured for resistance changes in the temperature range of 150-350° C. The results are shown in Table 1.

TABLE 1

| | Temper- | | Minium | Maximum | Change of |
|---|---|---|---|---|---|
| | ature | Time | Resistance | Resistance | resistance |
| | (° C.) | (Hour) | (KΩ) | (KΩ) | (%) |
| Comparative | 150 | 1000 | 11 | 13.8 | 10-38 |
| embodiment 1 | | | | | |
| Comparative | 350 | 168 | 12.5 | 19 | 25-90 |
| embodiment 2 | | | | | |
| Embodiment 1 | 150 | 1000 | 10 | 10.2 | 0-2 |
| Embodiment 2 | 350 | 168 | 10 | 11 | 0-10 |

As a result, the present disclosure can effectively enhance temperature tolerance. The resistance change in the temperature range of 150-350° C. is 2-10%, which prevents resistance drift and maintaining accuracy and reliability over duration in high-temperature environments.

What is claimed is:

1. A high-temperature resistant resistor, comprising:
a substrate layer;
a first surface electrode layer disposed on a first surface of the substrate layer;
a resistive layer partially attached on the first surface electrode layer and the substrate layer;
a second surface electrode layer aligned with the first surface electrode layer, and attached on the first surface electrode layer and the resistive layer, thereby clamping the resistive layer between the first surface electrode layer and the second surface electrode layer,
wherein the first surface electrode layer, the resistive layer, and the second surface electrode layer form a composite structure to suppress a resistance change of the high-temperature resistant resistor at high temperature.

2. The high-temperature resistant resistor according to claim 1, further comprising: a back electrode layer, wherein the back electrode layer is disposed on the second surface of the substrate layer with respect to the first surface electrode layer.

3. The high-temperature resistant resistor according to claim 2, further comprising a protective layer, wherein the protective layer is disposed with respect to the resistive layer and is attached on the second surface electrode layer and the resistive layer.

4. The high-temperature resistant resistor according to claim 3, wherein the protective layer is epoxy resin.

5. The high-temperature resistant resistor according to claim 3, further comprising a first side electrode layer, wherein the first side electrode layer partially cover the protective layer, the second surface electrode layer, the first surface electrode layer, the substrate layer, and the back electrode layer.

6. The high-temperature resistant resistor according to claim 3, further comprising a second side electrode layer, wherein the second side electrode layer covers the first side electrode layer.

7. The high-temperature resistant resistor according to claim 3, wherein the first side electrode layer is made of nickel.

8. The high-temperature resistant resistor according to claim 6, wherein the second side electrode layer is made of tin.

9. The high-temperature resistant resistor according to claim 6, wherein the resistive layer is made of nickel-chromium alloy or silicon-chromium alloy.
